(19) United States
(12) Patent Application Publication
(10) Pub. No.: US 2008/0190012 A1
(43) Pub. Date: Aug. 14, 2008

(54) MULTI-FILAMENT FLY SWATTER

(76) Inventor: SID CHANTHALANGSY, ROCKFORD, IL (US)

Correspondence Address: KEITH FRANTZ, 401 WEST STATE STREET, SUITE 200, ROCKFORD, IL, 61101, US

(21) Appl. No.: 11/752,862

(22) Filed: May 23, 2007

Related U.S. Application Data
(60) Provisional application No. 60/803,204, filed on May 25, 2006.

(51) Int. Cl. A01M 3/02

(52) U.S. Cl. 43/137

(57) ABSTRACT

A fly swatter includes head that slides between a deployed position and a stored position, and a multi-filament element secured to the head for sliding therewith between said positions. In the deployed position, the multi-filament element fans out naturally from the top of the head in two dimensions, and is substantially flat in the third dimension. In the stored position, the head and multi-filament element are hidden within a housing.

### CROSS-REFERENCES TO RELATED APPLICATIONS

This application claims priority to U.S. Provisional Patent Application Ser. No. 60/803,204, filed May, 25, 2006, which provisional application is incorporated herein.

### INCORPORATION-BY-REFERENCE OF MATERIAL SUBMITTED ON A COMPACT DISC

Not Applicable.

### STATEMENT REGARDING FEDERALLY SPONSORED RESEARCH OR DEVELOPMENT

Not Applicable.

### BACKGROUND OF THE INVENTION

1. Field of Invention

The present invention relates to fly swatters.

More specifically, the invention relates to a fly swatter with a retractable, multi-filament swatting element for swatting flies and other insects.

2. Background Art

Several types of fly swatters are known in the art.

One basic fly swatter includes an elongated handle and a flexible swatting pad at the end of the handle. Fly swatters of this general type have been provided with numerous structural and decorative variations. A disadvantage of this general type of fly swatter is that it is relatively long, and therefore not conveniently portable, and must often be stored in out-of-the-way locations, not readily accessible when needed.

Fly swatters with retractable swatting elements are also known in the art. These types of fly swatters include use of complicated mechanical actuating arrangements for deploying and retracting swatting elements of various arrangements, such as actuating levers or extensions or push buttons with slides and/or slots, and/or include mechanical influences such as mechanical spreaders or separators or guiding structure to establish the swatting element structure in the deployed condition.

Thus, there is a need for a new and improved fly swatter that addresses the above-noted and additional known and readily apparent drawbacks and disadvantages of prior fly swatters.

### SUMMARY OF THE INVENTION

An important objective of the invention is to provide a new and unique fly swatter with a swatting element that is retractable into a housing when not in use, thereby eliminating the unsightly aspect of a conventional fly swatter with its always-exposed swatting element.

Another important objective of the invention is to provide a new and unique fly swatter with a swatting element that slides between a deployed position for swatting flies and a hidden stored position in the housing without the need for mechanical actuating arrangements of certain prior fly swatters.

Another important objective of the invention is to provide a new and unique fly swatter with a multi-filament swatting element that naturally fans out in the deployed position for swatting flies; thereby eliminating the need for mechanical influences and swatting element establishing structures of certain prior fly swatters.

Another important objective of the invention is to provide a new and unique fly swatter that is retractable into a compact, streamlined article for storing in a drawer, backpack or other receptacle, hanging on a hook, and keeping in any convenient location when not in use.

Another important objective of the invention is to provide a new and unique fly swatter that can be provided with a plain appearance, or a fashionable, trendy or decorative appearance, and can be provided in any color desired. Thus, unlike conventional fly swatters, a fly swatter, in accordance with the invention, will be “at-home” in an office as well as in a factory, in a home, and in a formal environment.

These and other objectives and advantages of the invention will become more apparent from the following detailed description when taken in conjunction with the accompanying drawings.

A fly swatter, in accordance with the invention, includes a head that slides between a deployed position and a stored position, and a multi-filament element secured to the head for sliding therewith between said positions. In the deployed position, the multi-filament element fans out naturally from the top of the head in two dimensions, and is substantially flat in the third dimension. In the stored position, the head and multi-filament element are hidden within a housing. The components of a preferred fly swatter are formed of lightweight, impact resistant, relatively rigid, molded plastic, and are configured for comfortable gripping and use in one hand. The body element and an optional cap can be configured for decorative effect.

### BRIEF DESCRIPTION OF THE DRAWINGS

FIG. 1 is a front view of a first embodiment fly swatter, in accordance with the invention, shown in its operative position or extended condition for swatting flies.

FIG. 2 is a side view of the fly swatter in its extended condition.

FIG. 3A is a top view of the fly swatter in its extended condition.

FIG. 3B is a top view of the fly swatter in its collapsed condition.

FIG. 4 is an enlarged cross-sectional view taken along line 4-4 of FIG. 3B, through the longitudinal axis of the fly swatter.

FIG. 5 is an enlarged cross-sectional view taken ninety degrees from the view shown in FIG. 4.

FIG. 6 is a further enlarged, fragmentary cross-sectional view of certain parts as shown in FIG. 4.

FIG. 7 is a front view of the fly swatter in its collapsed condition.

FIG. 8 is a front cross-sectional view of a cover for the fly swatter.

FIG. 9 is a side view of the fly swatter in its collapsed condition.

FIG. 10 is a front view of the fly swatter in its collapsed condition and with the cover in position over the open end thereof.

FIG. 11 is a top view of the fly swatter and cover shown in FIG. 10.

FIG. 12 is a front view of a second embodiment fly swatter, in accordance with the invention, shown in its operative position or extended condition for swatting flies.

FIG. 13 is a side cross-sectional view taken through the longitudinal axis of the second embodiment fly swatter as shown in FIG. 12 in its extended condition.

FIG. 14 is an enlarged cross-sectional view taken through the longitudinal axis of the second embodiment fly swatter in its retracted condition.

FIG. 15 is a top view of the second embodiment fly swatter as shown in FIG. 12 in its extended condition.

FIG. 16 is a perspective view of the second embodiment fly swatter as shown in FIG. 12 in its extended condition.

FIG. 17 is an enlarged, fragmentary view of certain parts of the second embodiment fly swatter.

While the invention is susceptible of various modifications and alternative constructions, certain illustrated embodiments have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

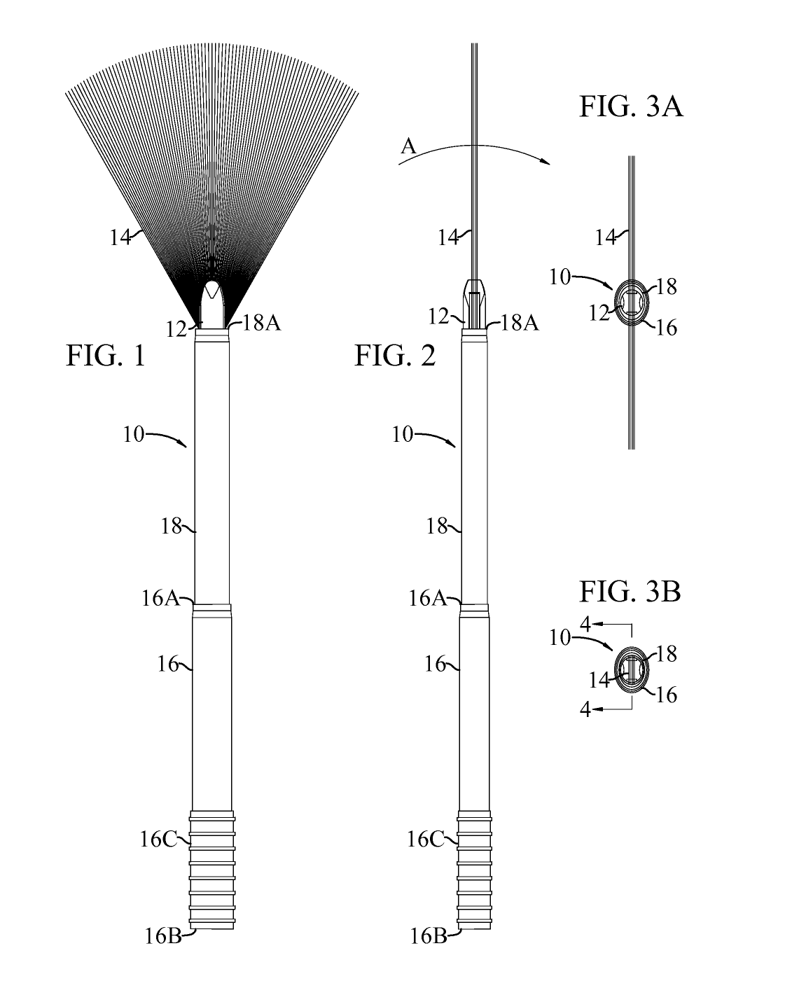

Referring now to the FIGS. 1-12 of the drawings, there is shown a first preferred embodiment fly swatter 10 in accordance with the invention.

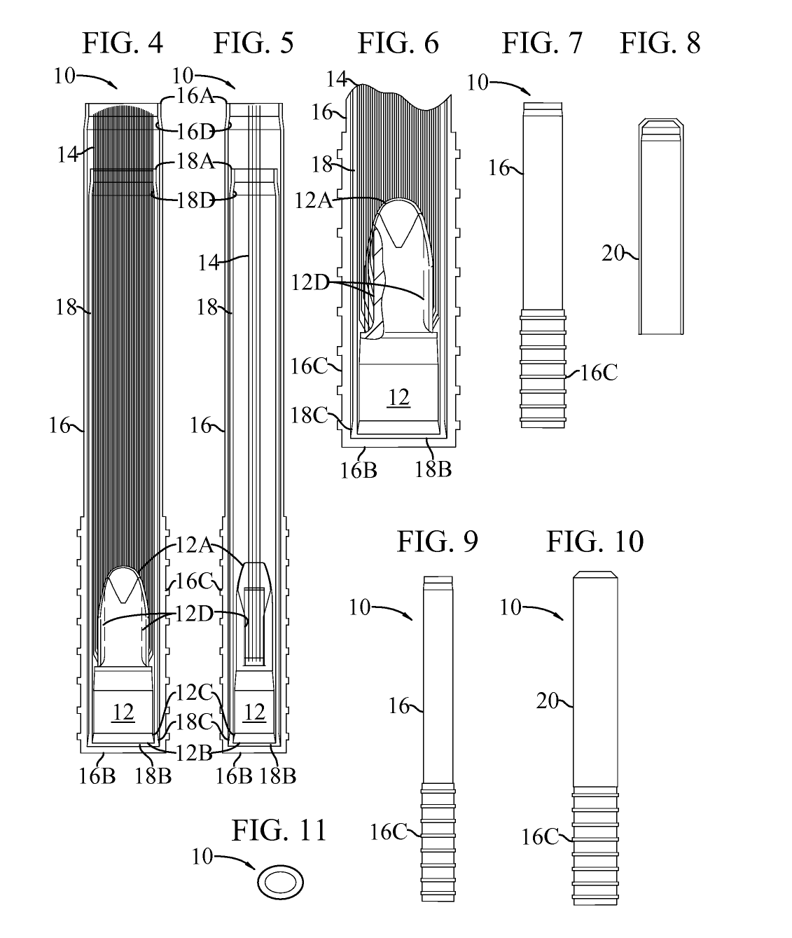

In general, the fly swatter 10 includes a head 12 that slides axially, with respect to the longitudinal center axis of the fly swatter, between a deployed position (see e.g., FIGS. 1-2) and a stored position (see e.g., FIGS. 4-5), and a multi-filament element 14 secured to the head for sliding therewith between said positions. In the stored position, the head and multi-filament element are located within and generally hidden in a protective housing. In the deployed position, the head extends only from one end of the housing, and the multi-filament element resiliently fans out from the exposed end of the head in two dimensions as shown in FIG. 1, and is substantially flat in the third dimension as shown in FIG. 2, for swatting flies and other bugs and insects.

The preferred fly swatter 10 includes a handle 16, an extension 18 in telescoping relation with the handle, and the head 12 and multi-filament swatting element 14 in sliding relation with the extension.

In the embodiment shown, the handle 16 and extension 18 are elongated, generally cylindrical, tubular elements, with upper open ends 16A, 18A and lower ends 16B, 18B, and are arranged such that the extension telescopes axially out of and into the upper open end of the handle between extended (see e.g., FIGS. 1-2) and retracted (see e.g., FIGS. 4-5) positions, and the head slides out of and into the upper open end of the extension between its deployed and stored positions.

In preferred embodiments, the handle 16 and extension 18 are formed with relatively thin walls of between approximately 1/32 inch to ⅛ inch, and together with the head, are formed of lightweight, impact resistant, molded plastic or relatively rigid polymer. The plastic construction of components enables the fly swatter to be provided with a plain appearance, or alternately a fashionable, trendy or decorative appearance, as such features can be readily molded at little to no additional costs (as compared with a plain appearance), and/or with any desired color. As will be evident, the extension, head and swatting element are actuated between their respective position without the need for a mechanical actuating arrangement. Thus, the handle and extension are formed with a continuous-material outer form or closed form, e.g., with the absence of slots, apertures, etc., through the sides thereof. This results in maximum strength and structural integrity for the handle and extension of a particular wall thickness, and further enables provision of a light-weight portable fly swatter.

For comfortable gripping in one hand, the fly swatter 10 shown includes a grip 16C at its lower end, and is oval in shape when viewed from above (FIGS, 3A, 3B, 11). In this instance, the grip includes sets of rings that are longitudinally spaced along the length of the handle, which, in addition to their functional gripping aspect, are also illustrative of a decorative element that may be integrally molded into the housing. Advantageously, the oval shape provides angular guidance of the sliding and telescoping elements in the fly swatter, resulting in pre-established angular orientation of the swatting element in its deployed position. This anti-rotation aspect prevents inadvertent rotation of the swatting element when striking a surface, and insures full contact of the width of the swatting element when struck squarely against the surface, to swat a fly on the surface. Alternately, a fly swatter in accordance with the invention may be provided as round or with any other convenient shape, which are preferably provided with an anti-rotation formation (e.g., hex-shaped in lateral cross-section) or form (e.g., a tab integrally formed in one part such as the head that slides in a longitudinally extending groove in the extension) between the head and extension, and optionally, between the extension and handle.

To maintain the extension 18 and head 12 in the fly swatter 10, the handle 16 and extension include cooperative elements to limit telescoping movement of the extension in the handle in both directions, and the extension and head include cooperative elements to limit sliding movement of the head in the extension in both directions.

In the embodiment shown, the retracted position of the extension 18 is established by the closed bottom end 16B of the handle 16 and the lower end 18B of the extension (see FIGS. 4-6) that contacts the bottom 16B. The extended position of the extension is cooperatively established by a flair 18C on the extension and an inwardly angled lip or taper 16D on the handle. In the embodiment shown, the flair 18C is established at the bottom of the extension and the taper 16D is established at the upper end of the handle to accommodate a maximum stroke for the lengths of extension and handle provided. Similarly, the stored position of the head 12 is established by the closed bottom end 18B of the extension and the lower end 12B of the head, and the deployed position of the head is cooperatively established by a flair 12C at the bottom of the head and an inwardly angled lip or taper 18D at the top of the extension. These elements keep the extension and head from falling out of (or removal from) either end of the handle and extension, respectively. In addition, the corresponding flairs and tapers frictionally engage to maintain the extension and head in their extended and deployed positions during use of the fly swatter, and thereby also establish an alternate anti-rotation formation between the frictionally engaged parts. Alternate arrangements will be readily provided and may be utilized for limiting the telescoping movement of the extension and the head in the fly swatter within the scope of the invention. For example, the lower ends of the handle and extension are shown as molded closed, but those skilled in the art will appreciate that closed lower ends may be established with separate caps or plugs secured to the lower ends of the tubular extension and/or handle. Additionally, for example, internal tabs or a continuous bead may be provided at the lower ends of the handle and extension on or around the inside profiles thereof to frictionally engage the outer profiles of the lower ends of the extension and head, respectively, in their stored position, to frictionally assist in maintaining the extension and head in their stored position in the handle.

In preferred embodiments, the handle 16 and the extension 18 are sized and configured to prevent significant tipping or tilting of the extension as it telescopes between its extended and retracted positions. In the embodiment shown, the length of the extension is sized and configured to slide freely through the upper open end 16A of the handle, but with relatively close dimensional clearance to maintain alignment along the longitudinal center axes thereof as the extension slides into and out of the handle. This is accomplished with a close clearance between (i) the inside bore of the handle and the flair 18C at the lower end of the extension, and (ii) the outside dimensions of the extension length and the inside dimensions of the taper 16D at the top of the handle. Similarly, the extension and head are sized and configured such that the head slides freely in and out of the upper end of the extension, but with relatively close dimensional clearance to maintain alignment along the center axes thereof and prevent significant tipping or tilting of the head.

The swatting element 14 comprises multiple plastic filaments or hair-like strands embedded or glued or otherwise secured to the upper end of the head 12. In the embodiment shown, the head is rounded at its upper end 12A for embedding the center filaments, and opposite sides of the head are provided with slots 12D for embedding side filaments. When viewed from the side as in FIGS. 2 and 5, the swatting element shown includes a small number, such as three or four, rows of filaments embedded in the head. As can be seen in FIG. 6, the filaments extend from the head at pre-established, progressively increasing angles from the center filament outwardly to the side filaments. With the head in its deployed position, and the embedding locations of the filaments at least substantially above the open end of the extension, the filaments at these pre-established, embedded angles resiliently and naturally fan out in substantially two dimensions as shown in FIG. 1 without the need for mechanical influences. When the head slides into the extension, the filaments resiliently bend, fold or collapse into the space in the slots 12D and generally in the extension as shown in FIGS. 4-6. The head shown, rounded and slotted at the filament receiving locations, enables provision of an extremely compact and streamlined fly swatter. The substantially constant cross-section of the housing and extension, without an enlarged fan-guiding structure or external filament influence at the open end of the extension, and the substantially flat swatting element when viewed from the side, further contributes to the compact, streamlined nature of the fly swatter. Alternate head and multi-filament arrangements may be utilized in a fly swatter within the scope of the invention. The head shown is rounded downwardly from the center towards the opposite sides. Alternately, for example, the head may be formed to angle downwardly from the center towards the opposite sides.

With the foregoing arrangement, the swatting element of the fly swatter can be deployed from its stored position by gripping the handle and flipping or snapping the swatter to impart a momentum to the head and extension and thereby cause the head and extension to telescope out from the handle. After use, the extension and swatting element can be returned to their retracted and stored conditions by manually pushing the head and extension into the handle, and/or tapping the bottom of the handle into the palm of the other hand or onto a table top or other surface to break the frictional hold between the handle and extension, and between the extension and head, and impart a momentum (with gravity) to cause the head and extension to drop into the handle.

The filaments of the swatting element 14 are made from resilient, durable, somewhat stiff, plastic or relatively rigid polymer strands such as commonly used in plastic brushes such that the filaments extend generally straight when in the deployed position regardless of the orientation of the fly swatter (i.e., the filaments remaining free-standing upright when the fly swatter is oriented as shown in FIGS. 1 and 2). Thus, in the embodiment shown, the filaments, in their deployed position, extend longitudinally through planes that run parallel to the center longitudinal axis of the fly swatter. The filaments are further configured in size and spacing to establish substantial space between the filaments, particularly as approaching the free ends of the filaments when viewing the face of the swatting element as in FIG. 1; with sufficiently open space so that the swatting element exhibits small air resistance, and therefore does not produce significant air movement when the fly swatter is manually snapped or swung through a short arc such as indicated by arrow A in FIG. 2 for swatting a fly. Otherwise, snapping or swinging the fly swatter in this manner would simply “blow” the fly out of the way before it could be struck by the swatting element.

The fly swatter 10 optionally includes a cap 20 such as shown in FIG. 8 for positioning over the open end of the handle and extension, and any exposed ends of the swatting element to further retain the extension, head and swatting element in their stored positions. The cap is sized to fit snugly onto the outside profile of the handle from its open end towards the grip section (see FIGS. 10-11), but a suitable cap may be alternately configured within the scope of the invention. Thus, the outside profile of the upper end portion of the handle either extends parallel to the longitudinal axis thereof, or tapers inwardly upon progressing towards the upper free end to slidably receive and frictionally engage an axial length of the inside profile of the cap.

The preferred fly swatter 10 is configured for ease of one-handed use, and to collapse for convenient storage such as in a drawer. In one exemplary embodiment, the handle, extension and head are approximately 16 to 22 inches long in the extended condition, and are approximately 5 to 8 inches long in the collapsed condition. Alternate storage arrangements may be provided for the fly swatter, including, but not limited to provision of a hook, hole, clip, hanging loop, cord and the like extending from the handle.

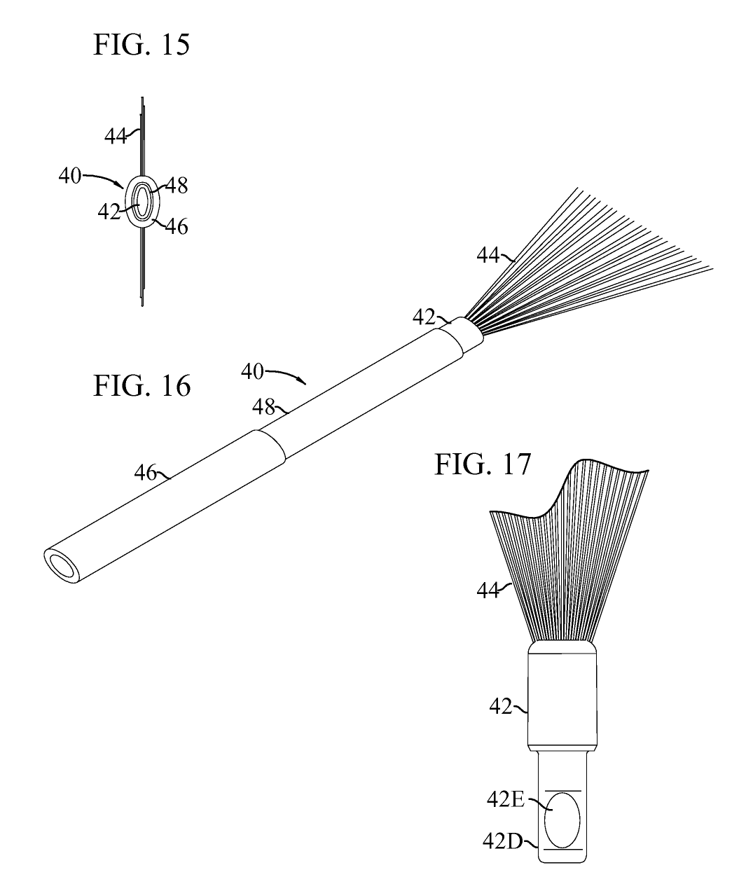

Turning now to the FIGS. 13-17, there is shown a second preferred embodiment fly swatter 40, in accordance with the invention. The fly swatter 40 is similar in construction and operation as fly swatter 10, with similar elements and components as generally described above but identified with reference numerals incremented by 30.

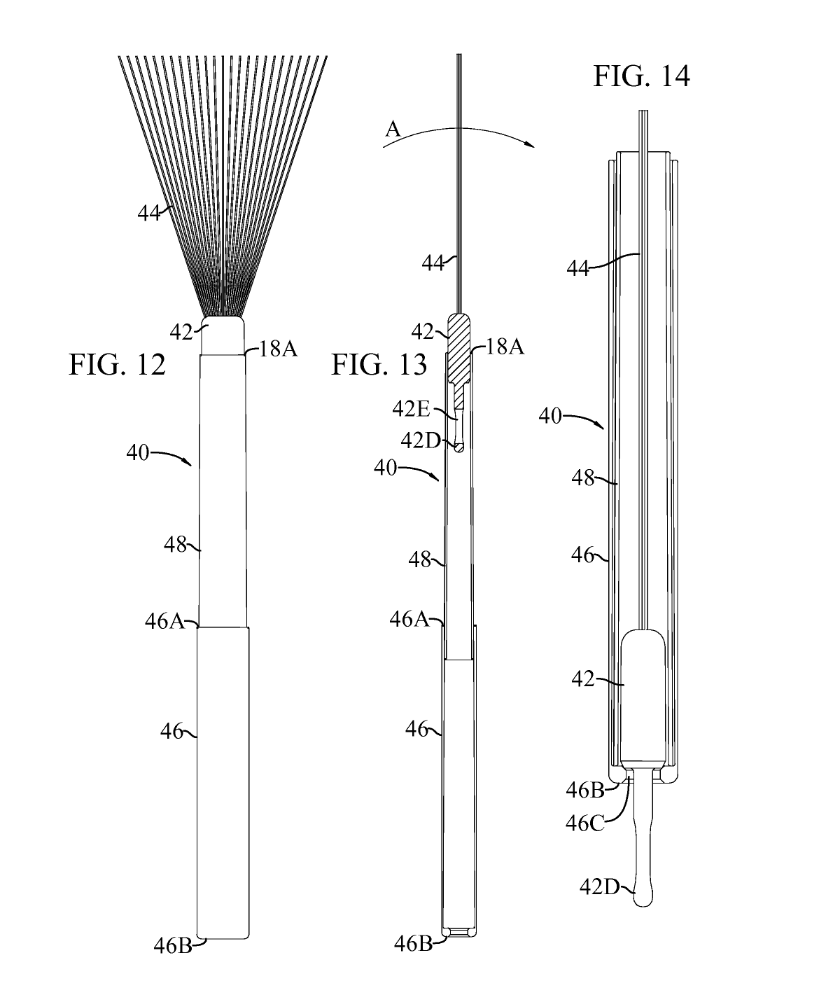

Thus, the fly swatter 40 includes a head 42, a multi-filament swatting element 44, an extension 48, and a handle 46. The handle 46 and extension 48 are generally tubular, with upper open ends 46A, 48A and lower ends 46B, 48B such that the head, the multi-filament swatting element, and the extension telescopically slide between a stored/retracted position in a handle (see e.g., FIG. 13) and a deployed/extended position wherein the multi-filament resiliently fans out in two dimensions from the head for swatting flies (see e.g., FIGS. 12-13 and 15-16). The extended position of the extension is cooperatively established by a taper 48C on the extension and an inwardly angled taper 46D on the handle.

In this instance, the fly swatter 40 includes a smooth gripping section at the lower end of the handle 46 for alternate comfortable gripping in one hand. The filaments of the swatting element 44 extend only from the upper rounded end of the head 42, and thus not from the sides of the head. The retracted position of the extension 48 is established by a lower, inwardly extending shoulder at 46B of the handle and the lower end 48B of the extension (see FIG. 14) that contacts the shoulder.

The fly swatter 40 further includes a hanger element 42D integrally molded with (or otherwise extending from) the head 42 for moving with the head between a retracted position when using the fly swatter and an exposed position for storage of the fly swatter when not in use. The hanger element shown is an integral ring with a center hole 42E from which the fly swatter can be hung. The hanger element may be provided in other forms, such as a hook with an open side or loop element. As shown in FIG. 13, the hanger element is located on the end of the head opposite the multi-filament element 44, extending in the opposite direction from the head, such that the hanger element extends through a hole 46C formed in the bottom of the handle to an exposed position with the head in its stored position, and the hanger element is retracted into the handle with the head in its deployed position (see e.g., FIGS. 13, 16). Retraction of the hanging element when using the fly swatter prevents it from interfering with ease of use of the fly swatter.

With the foregoing arrangement, the swatting element of the fly swatter 40 can be deployed and returned to its compact retracted position as described above for fly swatter 10. In this instance, the filaments extend slightly past the end of the extension when stored, and thus the swatting element may be alternately deployed by gripping the free ends of the filaments, and manually drawing the filaments and head through the extension, and the extension out from the handle. And the fly swatter 40 may be stored after use by hanging it from its hanging element extending from the base of the handle.

Those skilled in the arts will appreciate that a fly swatter, in accordance with the invention, may be provided with additional or alternately configured components, some of which are noted above, but others of which the skilled artisan will readily devise.

From the foregoing, it will be apparent that the present invention brings to the art a new and unique fly swatter with a multi-filament swatting element that fans out in a deployed position for swatting flies and that retracts into a stored position for convenience in storage of the entire fly swatter. By virtue of a swatting element sliding between a deployed position for swatting flies and a hidden storage position when not in use, a fly swatter, in accordance with the invention, eliminates the unsightly aspect of the conventional fly swatter with its always-exposed swatting element. A fly swatter, in accordance with the invention, is compact, and can be stored in a drawer, hung on a hook, or kept in any convenient location for ready use. A fly swatter, in accordance with the invention, can also be provided with a plain appearance, or a fashionable, trendy or decorative appearance, and it can be provided in any color desired. Thus, unlike conventional fly swatters, a fly swatter, in accordance with the invention, will be “at-home” in an office as well as in a factory, in a home, and in a formal environment.

As used herein, the directional indicators including, but not limited to, top, bottom, upper and lower are used for explanatory purposes only in relation to the fly swatter as shown in the drawings. Of course, the actual orientation of the fly swatter will ever change during use, and there is no intention to limit the disclosure or appended claims by the use of such directional indicators.

1. A fly swatter comprising:
a) a tubular housing having an open upper end and a lower end and a longitudinal center axis extending therebetween;
b) a head carried in the housing for axial sliding between a deployed position at the open upper end of the housing and a stored position in the housing; the head having an upper end exposed at the upper end of the housing and the remainder of the head contained entirely within the housing when in said deployed position; and
c) a multi-filament swatting element secured to the head for sliding therewith between said positions, the multi-filament swatting element being located generally within in the housing when in the stored position, and extending from the upper end of the housing when in the deployed position; the multi-filament swatting element comprising plastic standing filaments having ends secured to the head and extending therefrom to free ends at pre-established, progressively increasing angles from center filaments outwardly towards side filaments to cause the filaments to naturally fan out in the deployed position and resiliently collapse into the housing in the stored position, the free ends of the filaments being spaced apart for low air resistance when snapped or swung through an arc for swatting a fly.

2. The fly swatter as defined in claim 1 in which the housing includes a tubular handle with an open upper end, and a tubular extension with an open upper end; wherein the extension telescopes out of and into the upper end of the handle between extended and retracted positions; and wherein the head and multi-filament swatting element slide out of and into the upper end of the extension between said deployed and stored positions.

3. The fly swatter as defined in claim 2 in which the handle is formed of molded plastic, and is provided with a molded external decorative element.

4. The fly swatter as defined in claim 3 in which the handle includes a gripping section with external grip-enhancing elements.

5. The fly swatter as defined in claim 2 further comprising cooperative anti-rotation structure between the handle and the extension when in its extended position, and between the extension and the head when in its deployed position.

6. The fly swatter as defined in claim 2 in which the multi-filament swatting element fans out in two dimensions in the deployed position, but remains substantially flat in the third dimension in both the deployed and retracted positions.

7. The fly swatter as defined in claim 6 in which the handle and the extension and the head are oval in cross-section to establish anti-rotation structure therebetween when the extension and head are in their extended and deployed positions.

8. The fly swatter as defined in claim 2 in which the extension frictionally engages the open upper end of the handle when in the extended position, and the head frictionally engages the open upper end of the extension when in the deployed position.

9. The fly swatter as defined in claim 2 in which the head includes opposite sides, and the head is one of rounded or angled downwardly from the center towards the opposite sides.

10. The fly swatter as defined in claim 9 in which the sides of the head are formed with slots in which the side filaments are embedded at said progressively increasing angle, and into which the side filaments relocate into when the head is in its stored position.

11. The fly swatter as defined in claim 2 in which the embedded ends of the filaments are at least substantially above the open end of the extension.

12. The fly swatter as defined in claim 2 further comprising a removable cap on the upper end of the handle with the extension and head in their retracted and stored positions.

13. The fly swatter as defined in claim 2 further comprising a hanger element extending from the handle.

14. The fly swatter as defined in claim 13 in which the hanger element extends from the head, and the lower end of the handle is formed with an opening through which the hanger element is exposed with the head in the stored position, such that the hanger element retracts into the handle as the head moves towards the deployed position.
